(19) United States
(12) Patent Application Publication
(10) Pub. No.: US 2022/0161490 A1
(43) Pub. Date: May 26, 2022

(54) SYSTEMS AND METHODS FOR VOID REDUCTION IN ADDITIVE MANUFACTURING

(71) Applicants: Ankur Jain, Coppell, TX (US); Darshan Ravoori Babu, Chandler, AZ (US); Hardikkumar Prajapati, Tempe, AZ (US); Swapnil Suryakant Salvi, Arlington, TX (US)

(72) Inventors: Ankur Jain, Coppell, TX (US); Darshan Ravoori Babu, Chandler, AZ (US); Hardikkumar Prajapati, Tempe, AZ (US); Swapnil Suryakant Salvi, Arlington, TX (US)

(21) Appl. No.: 17/530,858

(22) Filed: Nov. 19, 2021

Related U.S. Application Data
(60) Provisional application No. 63/118,377, filed on Nov. 25, 2020.

(51) Int. Cl. B29C 64/218; B33Y 10/00; B33Y 30/00; B33Y 80/00; B29C 64/118; B29C 64/393; B33Y 50/02

(52) U.S. Cl. CPC B29C 64/218; B33Y 10/00; B33Y 30/00; B33Y 50/02; B29C 64/118; B29C 64/393; B33Y 80/00

(57) ABSTRACT

Disclosed herein is a system comprising a) a nozzle comprising an aperture configured to dispense a material to form a material layer on a build plate, and b) one or more members positioned in a spatial configuration along the x and z-axis relative to the nozzle such that the one or more members are configured to apply a compression load on the layer of the material and to form a manufactured part having a reduced void fraction.

### CROSS-REFERENCE TO RELATED APPLICATIONS

This application claims benefit of U.S. Provisional Application No. 63/118,377, filed Nov. 25, 2020, the content of which is incorporated by reference herein in its whole entirety.

### TECHNICAL FIELD

The present invention generally relates to systems used in additive manufacturing and methods of making articles utilizing such systems.

### BACKGROUND

Additive Manufacturing (AM) is widely used to manufacture parts with complicated geometries that are challenging to produce through conventional manufacturing methods. Typically, a three-dimensional geometry is sliced into multiple layers along the build direction, and the part is fabricated through the layer-by-layer addition of material. A number of different types of AM processes have been developed for both metal and polymer materials. A prominent polymer AM process is the Fused Filament Fabrication (FFF), in which a polymer wire is heated to above glass transition and dispensed through a rastering nozzle on top of previously deposited layers.

Poor thermal and mechanical properties of FFF-printed parts is a well-known challenge that must be overcome in order to produce functional parts that can withstand a significant load. The directional nature of filament rastering and the formation of voids between filaments is known to result in poor and anisotropic properties. Neck growth between neighboring filaments is an important process that governs the mechanical strength of the printed part. The cooling rate of interface temperature between two filaments layers plays a significant role in polymer chain diffusion and neck growth—the slower the cooling, the more effective the neck growth process is. Poor adhesion and void formation may occur if the interface cools down too fast. The number and size of such voids greatly influence the mechanical properties of FFF-printed parts. Minimizing voids during FFF remains a key technological challenge.

In view of the importance of minimizing void formation, a number of studies have investigated the effect of process parameters such as print speed, layer width, print temperature, infill percentage, and layer orientation on the void formation and the resulting thermal and mechanical properties of polymer parts. The extent of void formation and resulting anisotropy in mechanical properties has been investigated as a function of print speed and raster orientation. Tensile strength of the printed part has been correlated with layer height. Maximum and minimum tensile strengths were observed at raster angles of 0° and 90°, respectively, which was explained on the basis of faster failure due to the load being imposed on the voids in the 90° case.

Since void formation is intricately linked to the filament cooling process, in addition, a number of process modifications have also been proposed to provide thermal energy in order to slow down filament cooling and reduce void formation. Nozzle-integrated in situ heating, infrared (IR) heating, microwave heating, laser heating, and hot air heating are examples of such thermally-driven process modifications. However, these often consume significant energy and may have undesirable thermal side effects, such as material evaporation and internal microcrack generation. Post-fabrication thermal annealing has improved thermal and mechanical properties but may require significant time and cause significant warping.

Accordingly, a need exists for alternative systems and methods of making articles through additive manufacturing, where the articles have a reduced void formation. These needs and other needs are at least partially satisfied by the present disclosure.

### SUMMARY

The present invention is directed to a system comprising a) a nozzle comprising an aperture configured to dispense a material to form a material layer on a build plate; the nozzle is configured to move along x, y, and/or z-axis, and/or is configured to rotate; and wherein there is substantially no contact between any part of the nozzle other than an optional contact of the nozzle's aperture and the layer of the material and/or the build plate during dispense and/or the nozzle's movement and/or rotation, and b) one or more members positioned in a spatial configuration along the x and z-axis relative to the nozzle such that the one or more members are configured to apply a compression load on the layer of the material, wherein at least one of the one or more members comprises a cylinder having a proximal end and a distal end, wherein the cylinder comprises at least one rollerball having a diameter d1, wherein the distal end of the cylinder has an aperture having a diameter d2, wherein the d2 is smaller than d1, and wherein the aperture is configured to partially expose the at least one rollerball to the material layer and/or the build plate such that at least a portion of the rollerball is in contact with the material layer and/or the build plate, and wherein the at least one rollerball is configured to at least partially move along the z-axis and/or rotate within the cylinder.

In still further aspects, disclosed herein is a system where the spatial configuration comprises positioning the one or more members such that the one or more members pre-face the nozzle in the x-axis direction or the one or more members trail the nozzle in the x-axis direction. While in other aspects, the system can comprise two members positioned such that a first member pre-faces the nozzle and a second member trails the nozzle in the x-axis direction.

Also disclosed herein is a manufactured part comprising a plurality of compressed filaments, wherein a plurality of first compressed filaments forming a first layer; a plurally of second compressed filaments forming a second layer compressed against the first layer, and wherein a plurality of last compressed filaments forming a last layer compressed against a layer before the last layer, and wherein a void fraction of the manufactured part is between about 0.01% to about 10%. In still further aspects, disclosed is the manufactured part where any two adjacent compressed filaments in each layer are compressed against each other.

Still further disclosed herein is a method of forming a manufactured part, wherein the method comprising: a) disposing a material on a building plate from an aperture of a nozzle to form a layer of material, wherein the nozzle is configured to move along x, y, and/or z-axis, and/or is configured to rotate; and wherein there is substantially no contact between any part of the nozzle other than an optional contact of the nozzle's aperture and the layer of the material and/or the build plate during disposing step and/or the nozzle's movement and/or rotation; b) applying a compression load on at least a portion of the layer of material with one or more members, wherein the one or more members positioned in a spatial configuration along x and z-axis relative to the nozzle such that the one or more members are configured to apply a compression load on the one or more layers of the material, wherein at least one of the one or more members comprises a cylinder having a proximal end and a distal end, wherein the cylinder comprises at least one rollerball having a diameter d1, wherein the distal end of the cylinder has an aperture having a diameter d2, wherein the d2 is smaller than d1, and wherein the aperture is configured partially expose the at least one rollerball to the material layer and/or the build plate such that at least a portion of the rollerball is in contact with the material layer and/or the build plate, and wherein the at least one rollerball is configured to at least partially move along the z-axis and/or rotate within the cylinder; and c) forming the manufactured part having a void fraction of between about 0.01% to about 10%.

Additional aspects of the disclosure will be set forth, in part, in the detailed description, figures, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF DRAWINGS

FIGS. 1A-11F show a schematic diagram of an exemplary system in various aspects.

FIGS. 2A-2B depict schematics of an exemplary system in three exemplary aspects (FIG. 2A) and provide close-up photographs of the cylinder containing roller balls (FIG. 2B). A portion of the roller ball is seen protruding out of the cylinder; a roller ball is also shown outside the cylinder as an illustration.

FIGS. 3A-3B depict a schematic diagram of an exemplary experimental Fused Filament Fabrication (FFF) setup (FIG. 3A); a schematic diagram of the cylinder assembly integrated with the filament dispensing nozzle (FIG. 3B).

FIG. 4 depicts successive high-speed images for three exemplary aspects of the disclosure (Case A-Case C) to investigate the effect of compression load on the filament thickness. Numbers shown in the last set of images are the final thicknesses of the four-layer printed part. The roller balls are maintained at 110° C. in Cases B and C.

FIG. 5 depicts infrared-based temperature maps of the printing process comparing the baseline case with no roller (Case A) with the three roller ball case (Case C).

FIG. 6 depicts a post-deposition temperature decay profile for a filament with compression rolling with a different number of balls in one aspect. The baseline case is also shown for comparison.

FIG. 7 depicts a post-deposition temperature decay profile for a filament with compression rolling in systems described in FIGS. 1A-1F in one aspect.

FIG. 8 depicts successive high-speed images for three different values of the roller ball temperature. Numbers shown in the last set of images are the final thickness of the four-layer printed part. Three roller balls are used in each case, and the print speed is 3600 mm/min.

FIG. 9 depicts cross-sections of parts printed at three different print speeds with 0, 1, and 3 balls for compression rolling. The ball temperature is 110° C. for each case. Images from the baseline process are also shown for comparison.

FIGS. 10A-10B depict a void percentage as a function of print speed and roller ball temperature for one ball (FIG. 10A) and three ball cases (FIG. 10B).

FIG. 11 depicts cross-sections of parts printed with dual-sided rolling. Images are shown for one-ball and three-ball cases with three different print speeds. The ball temperature is 110° C. for each case. Images from the baseline process are also shown for comparison.

FIGS. 12A-12B depict a void percentage for dual-sided printing as a function of print speed and roller ball temperature for one ball (FIG. 12A) and three ball cases (FIG. 12B).

FIG. 13 depicts a stress-strain curve from tensile testing of Sample A printed with the print direction aligned with the loading direction. Performance of a sample printed with dual-sided rolling is compared with a baseline sample with no compression rolling.

FIG. 14 depicts a stress-strain curve from tensile testing of Sample B printed with the print direction normal to the loading direction. Performance of a sample printed with dual-sided rolling is compared with a baseline sample with no compression rolling.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the singular forms “a,” “an,” and “the” include plural referents unless the context clearly dictates otherwise. Thus, for example, reference to an “article” includes aspects having two or more such articles unless the context clearly indicates otherwise.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used herein, the terms “optional” or “optionally” mean that the subsequently described event or circumstance may or may not occur, and that the description includes instances where said event or circumstance occurs and instances where it does not.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims, which follow, reference will be made to a number of terms that shall be defined herein.

For the terms “for example” and “such as,” and grammatical equivalences thereof, the phrase “and without limitation” is understood to follow unless explicitly stated otherwise.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values inclusive of the recited values may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that, although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or a section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein interpreted accordingly.

As used herein, the term “substantially” means that the subsequently described event or circumstance completely occurs or that the subsequently described event or circumstance generally, typically, or approximately occurs.

Still further, the term “substantially” can in some aspects refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used, for example, and without limitation, in the context of a part substantially free of voids, for example, is intended to refer to a part that has less than about 5% of voids, less than about 4.5% of voids, less than about 4% of voids, less than about 3.5% of voids, less than about 3% of voids, less than about 2.5% of voids, less than about 2% of voids, less than about 1.5% of voids, less than about 1% of voids, less than about 0.5% of voids, less than about 0.1% of voids, less than about 0.05% of voids, or less than about 0.01% of voids, wherein the % relates to a fraction of the total volume of the part.

As used herein, the term “substantially,” in, for example, the context “substantially identical” or “substantially similar” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the term “substantially identical reference system” refers to a system comprising substantially identical components in the absence of an inventive component. In another exemplary aspect, the term “substantially,” in, for example, the context “substantially identical reference system” refers to a system comprising substantially identical components and wherein an inventive component is substituted with a common in the art component.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

The present invention may be understood more readily by reference to the following detailed description of various aspects of the invention and the examples included therein and to the Figures and their previous and following description.

### System

The rastering of discrete polymer filaments during Fused Filament Fabrication (FFF) results in the formation of voids between filaments, leading to poor properties and performance of the printed part. Minimizing voids and improving filament-to-filament adhesion remains a key technological challenge for FFF.

Here disclosed is a system that allows the in situ compression of just-deposited filament using a specially designed one or two members that are spatially integrated with the filament-dispensing nozzle. The one or two members of the present system comprise one or more roller balls that can compress the filament immediately after deposition when it is still soft. The rolling process can be characterized using high-speed imaging and infrared (IR) based thermography.

In situ compression of the filaments is shown, in some aspects, to result in a 10× reduction in void formation. Tensile test results show, in some exemplary and unlimiting aspects, 281% improvement in Ultimate Tensile Stress (UTS) and 495% improvement in material toughness as a result of compressive rolling of the filament. The rolling technique discussed in this work may help improve the properties and functionality of polymer parts printed using FFF.

Disclosed herein is a system, that in certain aspects, can be used for additive manufacturing. In such aspects, the system comprises a nozzle comprising an aperture configured to dispense a material to form a material layer on a build plate. In certain aspects, the material is dispensed continuously as a filament from the nozzle's aperture. In still further aspects, the nozzle is configured to move along x, y, and/or z-axis and/or is configured to rotate to further form a number of layers of the material. In still further aspects, the nozzle has substantially no contact between any part of the nozzle other than an optional contact of the nozzle's aperture and the layer of the material and/or the build plate during dispense and/or the nozzle's movement and/or rotation. It is understood that the nozzle height can be adjusted to accommodate the geometry change of a manufactured part. In such exemplary aspects, the only contact between the nozzle and the material layer and/or the build plate can be achieved through a possible contact with the nozzle's aperture dispensing the filaments. In yet still further aspects, the nozzle can have other parts or components that are in contact with the material's layer or the build plate.

In still further aspects, the disclosed system can further comprise one or more members positioned in a spatial configuration along the x and z-axis relative to the nozzle. The one or more members are configured to apply a compression load on the layer of the material. In still further aspects, the disclosed herein at least one of the one or more members comprises a cylinder having a proximal end and a distal end, wherein the cylinder comprises at least one roller ball having a diameter d1. In such exemplary aspects, the distal end of the cylinder has an aperture having a diameter d2, wherein the d2 is smaller than d1. In still further aspects, the cylinder's aperture is configured to partially expose the at least one roller ball to the material layer and/or the build plate such that at least a portion of the roller ball is in contact with the material layer and/or the build plate. In still further aspects, the at least one roller ball is configured to at least partially move along the z-axis and/or rotate within the cylinder.

It is understood that when the system moves along the x or y-axis, both the nozzle and the one or more members move along the same axis. When the one or more members move along the x or y-axis, the ball is at least partially exposed from the one or two member's apertures and is in substantial contact with the material layer and/or build plate. In still further aspects, the ball is configured to provide any desired pressure to compress the material layer during the process.

It is understood that in some aspects and as disclosed above, the one or more members can have a cylindrical form. However, it is understood that the shape is not limited, and other shapes of the member are also contemplated to achieve the desired compression. In yet still further aspects, the exemplary cylindrical member disclosed herein can be a barrel. In yet other aspects, the barrel can have a smooth inner surface that would minimize friction between this surface, and the roller ball disposed within it. In yet other aspects, the inner surface of the barrel or any other cylinder (or to that end, any other shape of the one or more members) can have an optional coating that can further minimize the friction with the roller ball.

In yet further aspects, the barrel or any other cylinder can have a plurality of thread positioned on an outer surface. This plurality of threads can allow coupling of the barrel with other additional components of the system.

In still further aspects, the roller ball can be substituted with a cylindrical roller that can be disposed within the one or more members. In yet other aspects, the one or more members can be represented by a cylindrical roller that is not hollow and is configured to apply the desired pressure on the material layer. It is understood that the roller itself or a mechanism responsible for applying the desired compression can be made of any material suitable for the desired application.

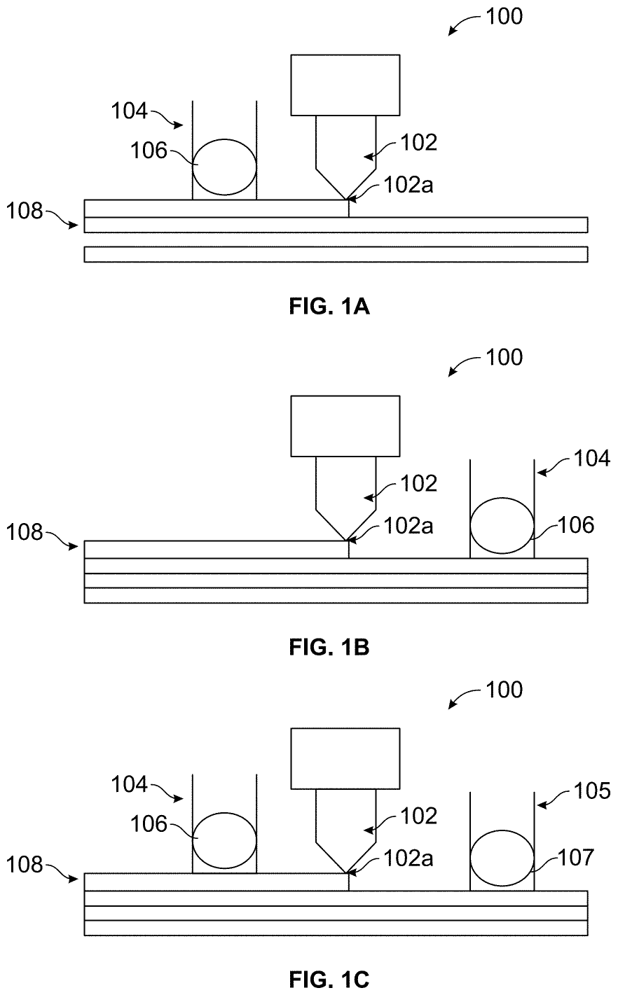

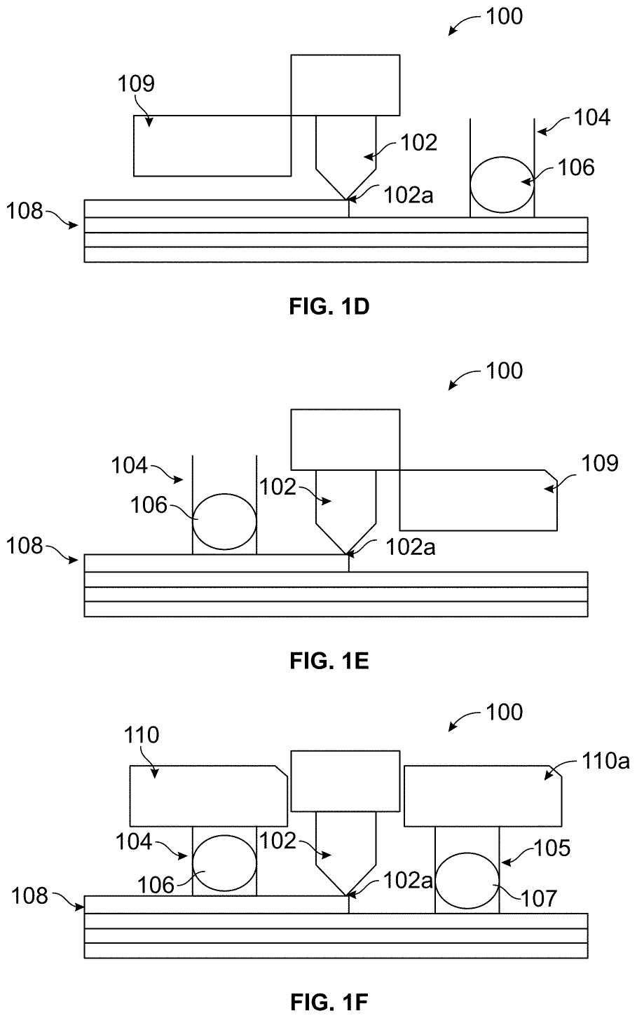

In still further aspects, the spatial configuration can comprise positioning the one or more members such that the one or more members pre-face the nozzle in the x-axis direction or the one or more members trail the nozzle in the x-axis direction. However, it is understood that since the system is configured to move along the build plate in the x-direction and then to have a U-turn, the same one or more members can be positioned either pre-facing the nozzle or trailing the nozzle depending on the travel direction. Some exemplary aspects of such configuration are shown in FIGS. 1A-1B. It can be seen that nozzle 102 can deposit filaments of material 108 through the aperture 102a. In some aspects, cylinder 104 can trail the nozzle 102 such that the ball 106 provides a desired compression load on a newly deposited filament (FIG. 1A). However, in other aspects, when for example, the system makes a U-turn, cylinder 104 trails the nozzle 102 such that the roller ball 106 provides an additional compression load on the previously disposed layer (FIG. 1B).

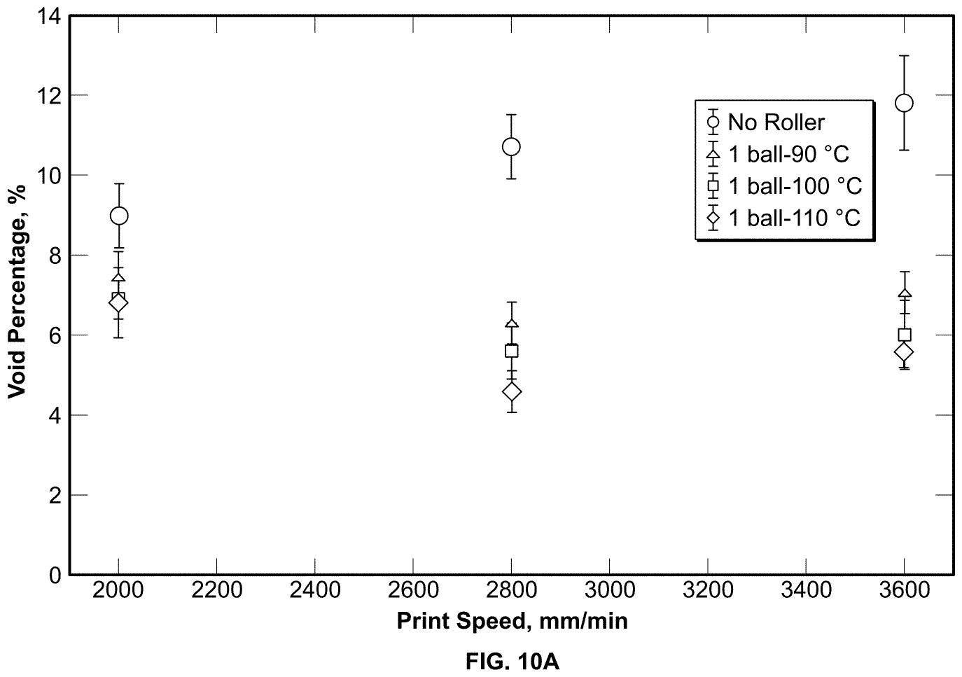

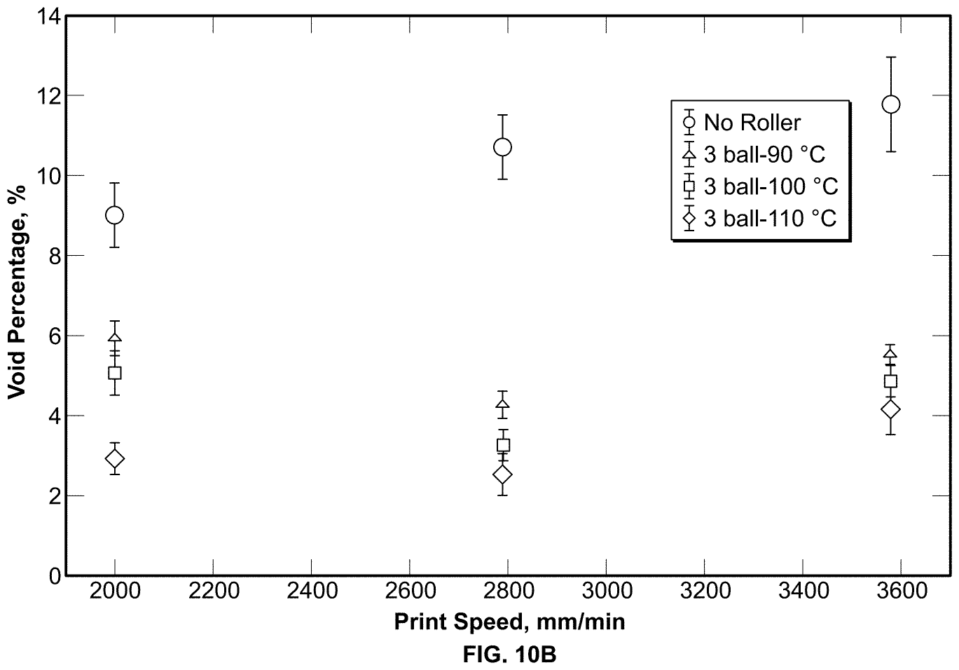

Also disclosed herein are the aspects where the system comprises two members positioned such that a first member pre-faces the nozzle and a second member trails the nozzle in the x-axis direction. This exemplary aspect is illustrated in FIG. 10. In this aspect, cylinder 104 is configured to trail the nozzle 102, while cylinder 105 pre-faces the nozzle.

In still further aspects, the one or more members can comprise more than one roller ball. In other aspects, if more than one member is present, each of the first and the second members can comprise more than one roller ball. In still further aspects, the cylinder can comprise two or more roller balls. In yet still further aspects, each cylinder can comprise 1, 2, 3, 4, 5, 6, 7, 8, 9, or even 10 roller balls if needed for the desired application. It is understood that the specific number of the balls in the cylinder can be determined by the desired compression load and the specific application.

It is understood that in some aspects, the compression is provided by the ball weight or through gravity. While in other aspects, the system can comprise additional components configured to exert force on the ball and to add to the desired values of the compression. In certain aspects, the compression load can be applied by a pulse (or oscillation) load mechanism. In such aspects, the cylinder can pulse (oscillate) in the z-direction, and z height can be adjusted to control roller contact with the material layers. In such aspects, the load can be controlled as on/off if needed instead of applying a continuous load over time.

There are also disclosed are aspects where the two or more balls are present in each cylinder, each of the roller balls are configured to at least partially rotate or move along the z-axis within the cylinder. It is understood that in such aspects, there is substantially no friction between two or more balls. It is further understood that the term “substantially no friction” as used herein indicates that there is no friction that would affect the system's performance.

In still further aspects, when more than one member is present in the system, the system can comprise a first member comprising the cylinder comprising the at least one rollerball and a second member comprising a heat block. Again such block 109 and the cylinder 104 can be positioned either pre-facing the nozzle or trailing as shown in FIGS. 1D and 1E. It is further understood that the block can have any dimensions. It is further understood that such dimension can be determined by the desired surface area where the compression load is applied. Some exemplary blocks that can be used for such a purpose are disclosed in U.S. Patent Application Publication No. 2020/0316866, the content of which is disclosed herein in its whole entirety.

In still further aspects, the material can comprise a polymer, metal, or a composite. In some aspects, the polymer is a thermoplastic polymer. In other aspects, example, the polymers can comprise polyphenylene sulfide, polyether ether ketones (PEEK), acrylonitrile butadiene styrene (ABS), polylactic acid (PLA), polycarbonates (PC), polystyrenes (PS) including styrene maleic anhydrides (SMA), polyketones, polyethers, poly ether ketone (PEK), poly ether ketone ketones, polyolefins, polyhydroxyalkanoates (PHA), polyacetals, polyesters including polyethylene terephthalates (PET) and polycaprolactones, polyoxyalkylenes, polyoxyalkylene/polyester copolymers, polyamides (PA) including nylons, polyolefins, polyvinyl chlorides (PVC), chlorinated polyvinyl chlorides (CPVC), polyvinylidene chlorides, acrylic resins, vinyl ester resins, phenolic resins, urea resins, melamine resins, epoxy resins, alkyd resins, polyalkyleneimines (e.g., polyethyleneimine), polyvinylpyrrolidone, polyallylamine, polyether polyamines (e.g., polyoxyethylene polyamine), or polyurethane elastomers, optionally copolymerized with comonomer units selected from ethylenically unsaturated carboxylic acids, ethylenically unsaturated carbonates, ethylenically unsaturated urethanes, ethylenically unsaturated alcohols, ethylenically unsaturated aromatics, alkyl acrylates, alkyl methacrylates, ethylene vinyl alcohols, vinyl acetates, styrenes, and hydroxyalkanoic acid, or blends thereof, copolymers thereof, derivatives thereof, or combinations thereof. Blends of the selected polymers may include blending the polymers with other materials. These polymers blends can also include, for example, at least one of glass beads, hollow glass spheres, other polymers, minerals, clays, flame-retardant additives, color additives, and/or other suitable materials.

The metals can comprise any metals suitable for the desired application and can comprise aluminum, aluminum alloys, titanium, titanium alloys, tungsten, tungsten alloys, vanadium, and vanadium alloys. Suitable ceramic materials can include aluminum oxide or alumina, zirconium oxide or zirconia, compact of particulate diamond, and/or pyrolytic carbon.

In still further aspects, each of the one or more members is configured to apply the same or different compression load. For example, and without limitation, the compression load applied on the nozzle pre-facing member can be the same or different from the compression load applied on the trailing member even if it is the same member just positioned differently during the nozzle pass and U-turn. If two or more members are present, whether it is a cylinder or a block, the compression load provided by each of them can be again the same or different depending on the specific application.

In still further aspects, the compression load can have any value depending on the equipment setup and compression load requirements, for example, and without limitation from about 0.01 N to about 10 N, including exemplary values of about 0.05 N, about 0.1 N, about 0.2 N, about 0.3 N, about 0.4 N, about 0.5 N, about 0.6 N, about 0.7 N, about 0.8 N, about 0.9 N, about 1 N, about 2 N, about 3 N, about 4 N, about 5 N, about 6 N, about 7 N, about 8N, and about 9 N. In still further aspects, the specific compression load can be determined based on the material being deposited. It is understood that different materials may require a different compression load to obtain the desired result. In yet further aspects, the amount of load can be controlled by the number of the roller balls within the cylinder, the weight of the balls, the size of the block, or an additional load applied on the one or more members by optional additional components that can be present in the system.

In still further aspects, the at least one roller ball that is in contact with the material layer and/or build plate is configured to move within the cylinder in response to a geometry of the material layer and/or the build layer. This allows the system to adapt to the specific geometry while applying the constant load over the whole length/width of the manufactured part.

In still further aspects, the one or more members are positioned at any gap, allowing achieving the desired outcome. For example and without limitations, the one or more members can be positioned at about 0.5 mm to about 50 mm from the nozzle in the x-axis direction, including exemplary values of about 1 mm about 5 mm, about 10 mm, about 15 mm, about 20 mm, about 25 mm, about 30 mm, about 35 mm, about 40 mm, and about 45 mm.

In still further aspects, the nozzle and/or the one or more members can be heated to any temperature above 0° C. depending on the desired material. In some exemplary and unlimiting aspects, the nozzle and/or the one or more members can be heated to a temperature between about 30° C. to about 250° C., including exemplary values of about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., and about 240° C. It is understood that the nozzle and each of the one or more members can be heated simultaneously or independently to the same or a different temperature.

In still further aspects, the build plate can also be heated to any temperature above 0° C. up to the temperature that is desired for the intended application. In some exemplary and unlimiting aspects, the build plate can be heated between about 30° C. to about 250° C., including exemplary values of about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., and about 240° C. It is understood that the build plate can be heated simultaneously or independently from the nozzle and each of the one or more members to the same or a different temperature.

It is further understood that the optimal temperature would be dependent on the specific material used to form the manufactured part, and therefore, temperatures provided above are not limiting.

It is further understood that the same or different heaters can be used to achieve the desired temperature. It is further understood that any known in the art heating devices can be utilized. For example, in some aspects, the heating can be performed with resistance heating, UV heating, IR heating, conventional heating, and the like. In yet still further aspects, the system and manufactured part can be placed in a controlled environment. For example, and without limitations, the system and the manufactured part can be placed in the chamber with the controlled temperature and moisture if needed.

Some exemplary aspects of the system having heaters attached to the cylinders are shown in FIG. 1F. In some aspects, the heater can provide an additional compression load if needed.

In still further aspects, the one or more members can be removably attached to the nozzle and configured to move along the x, y, and z-axis simultaneously with the nozzle. For example, the one or more members can be coupled to the nozzle along the z-axis of the nozzle at a specific distance from the nozzle. In such aspects, the height of the one or more members from the material layer and/or build plate and the distance from the nozzle can be controlled manually or automatically if needed.

In still further aspects, the nozzle is configured to move at any speed applicable to the desired application. For example and without limitations, the nozzle is configured to move at speed between about 1000 mm/min and about 4000 mm/min, including exemplary values of about 1250 mm/min, about 1500 mm/min, about 1750 mm/min, about 2000 mm/min, about 2250 mm/min, about 2500 mm/min, about 2750 mm/min, about 3000 mm/min, about 3250 mm/min, about 3500 mm/min, and about 3750 mm/min.

In still further aspects, the system can further comprise a control unit configured to independently adjust a temperature of the nozzle, build plate, the one or more members, and/or a speed of the nozzle. In yet other aspects, the control unit can also adjust the amount of load provided to the material layer and/or build plate either by automatically adjusting it or by informing the control engineer that the number of balls or their weight, or dimensions of the block (if used) need to be adjusted or changed. In further aspects, the control unit can comprise a machine learning software that can adjust the parameters in response to the obtained in situ experimental data. In still further aspects, the control system can also comprise any other necessary data processing software.

In still further aspects, the system can further comprise at least one sensor configured to measure a temperature of the nozzle, build plate, and/or the one or more members, and/or a speed of the nozzle, compression load, and/or a thickness of the one or more layers, and wherein the at least one sensor in a feedback loop with the control unit. In yet further aspects, the at least one sensor operates in situ during the manufacturing steps. Some exemplary and unlimiting sensors can include IR cameras, optical cameras, thermistors, thermocouples, or a combination thereof.

In still further aspects, the system can also comprise additional components that can control whether the one or more members are in continuous contact with the part being printed. In some aspects, where continuous contact is not desired, the system can comprise an electromagnetic actuator, a spring-based actuator, or any other suitable device capable of turning the compression action on/off by lifting the balls (or the block) above the part being printed.

In still further aspects, it is understood that the control system is configured to adjust each parameter (temperature, load, thickness, etc.) individually or simultaneously depending on the desired application.

In some exemplary and unlimiting aspects, the process of in situ filament compression rolling at a temperature above the material's glass transition temperature can be further studied via theoretical modeling if needed.

In still further aspects, it is understood that the system as presented can change the layer height due to the compression, and therefore, the control system can further comprise suitable components that can adjust height (thickness) settings to obtain the desired dimensions of the parts to be printed based on the output received from the layer thickness (height) sensor measurement. It is understood that the adjustment can be constant or gradual depending on the desired outcome.

In still further aspects, the system is configured to form at least two material layers wherein a void fraction of the at least two material layers is at least about 40% lower when compared to a substantially identical system with an absence of the one or more members. In yet other aspects, the void fraction is at least about 50% lower, about 100% lower, about 200% lower, about 300% lower, about 400% lower, about 500% lower, about 600% lower, about 700% lower, about 800% lower, about 900% lower, or even about 1000% lower when compared to a substantially identical system with an absence of the one or more members or any conventional system.

In still further aspects, the disclosed herein system can allow about 2×, about 3×, about 4×, about 5×, about 6×, about 7×, about 8×, about 9×, about 10×, or about 15× reduction in the void fraction of the manufactured part when compared to a substantially identical system with an absence of the one or more members or any conventional system.

In still further aspects, the system can be adapted to manufacture a part having any desired dimensions. For example, the system can be adapted to a large area additive manufacturing. For example, for large prints, the predeposited layer will cool down and be close to the surrounding environment temperature before the pre-deposition roller arrives, and therefore, the printing can be carried out in a thermally controlled environment or with a nozzle-integrated in situ heater.

### Articles

In certain aspects, disclosed herein is manufactured part comprising a plurality of compressed filaments, wherein a plurality of first compressed filaments forming a first layer, a plurally of second compressed filaments forming a second layer compressed against the first layer, and wherein a plurality of last compressed filaments forming a last layer compressed against a layer before the last layer, wherein a void fraction of the manufactured part is between about 0.01% to about 10%, including exemplary values of about 0.02, about 0.05%, about 0.07%, about 0.1%, about 0.2%, about 0.5%, about 0.7%, about 1%, about 1.2%, about 1.5%, about 1.7%, about 2.0%, about 2.2%, about 2.5%, about 2.7%, about 3%, about 3.2%, about 3.5%, about 3.7%, about 4.0%, about 4.2%, about 4.5%, about 4.7%, about 5.0%, about 5.2%, about 5.5%, about 5.7%, about 6%, about 6.2%, about 6.5%, about 6.7%, about 7.0%, about 7.2%, about 7.5%, about 7.7%, about 8.0%, about 8.2%, about 8.5%, about 8.7%, about 9%, about 9.2%, about 9.5%, and about 9.7%.

In still further aspects, wherein any two adjacent compressed filaments in each layer are compressed against each other.

In still further aspects, the manufactured part exhibits any measure of the desired ultimate strength. In some exemplary and unlimiting aspects, the ultimate strength can be between about 30 MPa to about 100 MPa, including exemplary values about 35 MPa, about 40 MPa, about 45 MPa, about 50 MPa, about 55 MPa, about 60 MPa, about 65 MPa, about 70 MPa, about 75 MPa, about 80 MPa, about 85 MPa, about 90 MPa, and about 95 MPa, and/or a toughness between about 2 to about 5 MJ/m³, including exemplary values of about 2.1 MJ/m³, about 2.2 MJ/m³, about 2.3 MJ/m³, about 2.4 MJ/m³, about 2.5 MJ/m³, about 2.6 MJ/m³, about 2.7 MJ/m³, about 2.8 MJ/m³, about 2.9 MJ/m³, about 3.0 MJ/m³, about 3.1 MJ/m³, about 3.2 MJ/m³, about 3.3 MJ/m³, about 3.4 MJ/m³, about 3.5 MJ/m³, about 3.6 MJ/m³, about 3.7 MJ/m³, about 3.8 MJ/m³, about 3.9 MJ/m³, about 4.0 MJ/m³, 4.1 MJ/m³, about 4.2 MJ/m³, about 4.3 MJ/m³, about 4.4 MJ/m³, about 4.5 MJ/m³, about 4.6 MJ/m³, about 4.7 MJ/m³, about 4.8 MJ/m³, and about 4.9 MJ/m³.

In still further aspects, the manufactured part disclosed herein exhibits an increase in an ultimate strength when compared to a baseline from about 10% to about 500%, including exemplary values of about 20% about 30%, about 35%, about 40%, about 45%, about 50%, about 55%, about 60%, about 65%, about 70%, about 75%, about 80%, about 85%, about 90%, about 100%, about 110%, about 120%, about 130%, about 140%, about 150%, about 160%, about 170%, about 180%, about 190%, about 200%, about 210%, about 220%, about 230%, about 240%, about 250%, about 260%, about 270%, about 280%, about 290%, about 300%, about 310%, about 320%, about 330%, about 340%, about 350%, about 360%, about 370%, about 380%, about 390%, about 400%, about 410%, about 420%, about 430%, about 440%, about 450%, about 460%, about 470%, about 480%, and about 490, when measured with a compressive rolling aligned with tensile load direction or normal to the tensile load direction. It is understood that the baseline measurements are obtained with substantially identical reference systems with an absence of the one or two members as disclosed herein.

In yet still further aspects, the manufactured part disclosed herein exhibits an increase in toughness when compared to a baseline, for example, and without limitation, from about 50% to about 1000%, including exemplary values of about 60%, about 70%, about 80%, about 90%, about 100%, about 120%, about 150%, about 170%, about 200%, about 220%, about 250%, about 270%, about 300%, about 320%, about 350%, about 370%, about 400%, about 420%, about 450%, about 470%, about 500%, about 520%, about 550%, about 570%, about 600%, about 620%, about 650%, about 670%, about 700%, about 720%, about 750%, about 770%, about 800%, about 820%, about 850%, about 870%, about 900%, about 920%, about 950%, about and 970%, when measured with a compressive rolling aligned with tensile load direction or normal to the tensile load direction. It is understood that the baseline measurements are obtained with substantially identical reference systems with an absence of the one or two members as disclosed herein.

### Methods

Also disclosed herein are methods of making the disclosed compositions and the disclosed articles. In certain aspects, disclosed herein is a method comprising first disposing a material on a building plate from an aperture of a nozzle to form a layer of material, wherein the nozzle is configured to move along x, y, and/or z-axis, and/or is configured to rotate; and wherein there is substantially no contact between any part of the nozzle other than an optional contact of the nozzle's aperture and the layer of the material and/or the build plate during disposing step and/or the nozzle's movement and/or rotation. In other aspects, the method further comprises applying a compression load on at least a portion of the layer of material with one or more members, wherein the one or more members positioned in a spatial configuration along x and z-axis relative to the nozzle such that the one or more members are configured to apply a compression load on the one or more layers of the material, wherein at least one of the one or more members comprises a cylinder having a proximal end and a distal end, wherein the cylinder comprises at least one rollerball having a diameter d1, wherein the distal end of the cylinder has an aperture having a diameter d2, wherein the d2 is smaller than d1, and wherein the aperture is configured partially expose the at least one rollerball to the material layer and/or the build plate such that at least a portion of the rollerball is in contact with the material layer and/or the build plate, and wherein the at least one rollerball is configured to at least partially move along the z-axis and/or rotate within the cylinder. In still further aspects, the method further comprises forming the manufactured part having a void fraction of between about 0.01% to about 10%, including exemplary values of about 0.02, about 0.05%, about 0.07%, about 0.1%, about 0.2%, about 0.5%, about 0.7%, about 1%, about 1.2%, about 1.5%, about 1.7%, about 2.0%, about 2.2%, about 2.5%, about 2.7%, about 3%, about 3.2%, about 3.5%, about 3.7%, about 4.0%, about 4.2%, about 4.5%, about 4.7%, about 5.0%, about 5.2%, about 5.5%, about 5.7%, about 6%, about 6.2%, about 6.5%, about 6.7%, about 7.0%, about 7.2%, about 7.5%, about 7.7%, about 8.0%, about 8.2%, about 8.5%, about 8.7%, about 9%, about 9.2%, about 9.5%, and about 9.7%.

In yet still, further aspects, the distal end of the cylinder can be tapered in to form the aperture.

In still further aspects, the disposing step comprises moving the nozzle in the x or y-axis direction at any desired speed. For example and without limitations, the nozzle can move at speed between about 1000 mm/min and about 4000 mm/min, including exemplary values of about 1250 mm/min, about 1500 mm/min, about 1750 mm/min, about 2000 mm/min, about 2250 mm/min, about 2500 mm/min, about 2750 mm/min, about 3000 mm/min, about 3250 mm/min, about 3500 mm/min, and about 3750 mm/min.

In yet further aspects, the method comprises heating the nozzle and/or one or more members to any temperature above 0° C. depending on the desired material. In some exemplary and unlimiting aspects, the nozzle and/or the one or more members can be heated to a temperature between about 30° C. to about 250° C., including exemplary values of about 40° C., about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., and about 240° C. It is understood that the nozzle and each of the one or more members can be heated simultaneously or independently to the same or a different temperature.

In yet still, further aspects, the method comprises adjusting the dimensions of the manufactured product. In such aspects, the dimensions of the manufactured product are adjusted by at least about 0.1%, at least about 0.2%, at least about 0.3%, at least about 0.4%, at least about 0.5%, at least about 0.6%, at least about 0.7%, at least about 0.8%, at least about 0.9%, or at least about 1.0% to compensate for a change in a thickness of the one or more layers due to the applied predetermined compression load.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for.

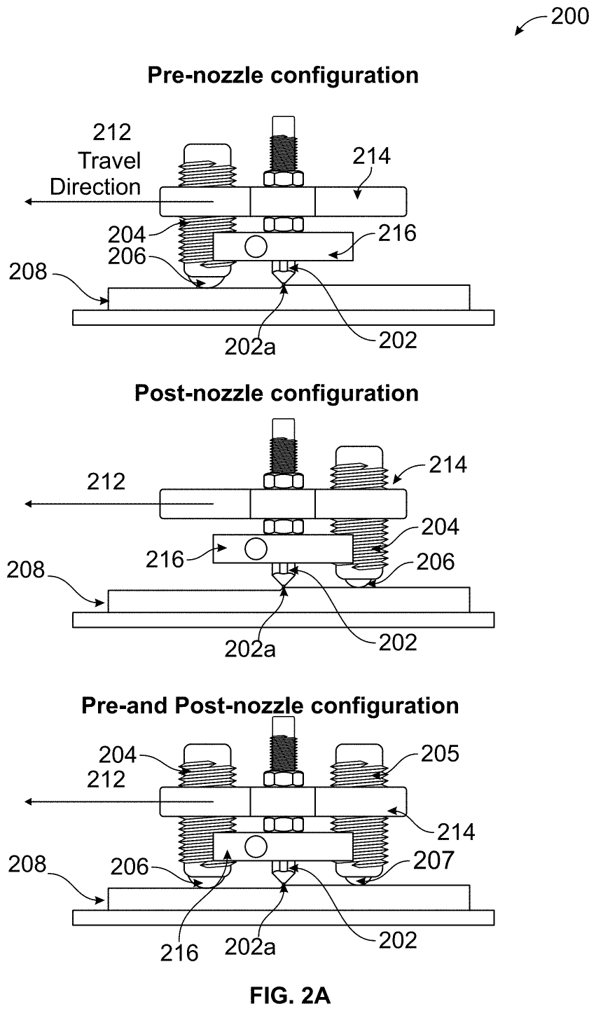

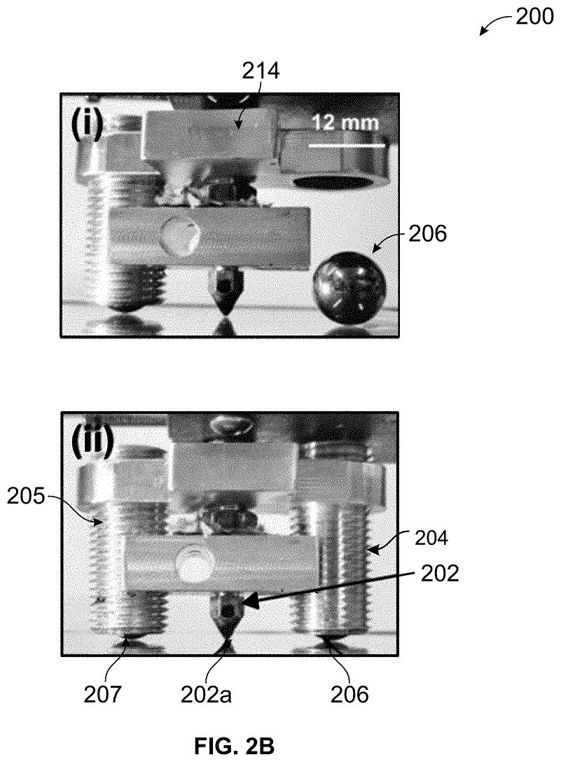

An experimental setup is designed and built to enable the application of compression load on the newly deposited filament. A set of experiments are carried out to study the impact of in situ compression load on the filament mesostructure as well as properties of printed parts. FIGS. 2A-2B show schematics and pictures of the technique for applying in situ compressions load. As shown herein and discussed in detail above, the system can have various configurations. Here, three different and exemplary configurations are shown on FIG. 2A. The figure shows a nozzle 202 having an aperture 202a connected to a cylinder 204 having at least one roller ball 206. It can be seen that a portion of the roller ball 204 is in contact with a layer of material 208. The top figure shows that cylinder 204 pre-faces the nozzle 202 in a travel direction along x-axis 212. The middle figure shows that cylinder 204 trails the nozzle 202 in a travel direction along x-axis 212.

The bottom figure shows a configuration where two cylinders are present. More specifically, cylinder 204 having at least one ball 206 pre-faces the nozzle 202, while cylinder 205 having at least one ball 207 trails the nozzle 202. The exemplary system shown in FIG. 2A also includes an optional post 216 connecting the nozzle 202 with cylinder 204 and/or cylinder 205. The system shown in FIG. 2A also shows an exemplary and unlimiting heater 214 that can, for example, heat the nozzle 202 and the cylinders 204 and 205 simultaneously. Again, it is understood that in some aspects, the heating can be done independently, while in other aspects, the heating can be done simultaneously. Also disclosed are aspects where the nozzle, for example, is heated, but the cylinder 204 and/or 205 are not. Yet, in other aspects, one or more cylinders can be heated, while the nozzle is not. Some exemplary photographs of the system having one cylinder (204) with at least one roller ball (206) and two cylinders (205 and 204) with at least one roller ball (206 and 207) are shown in FIG. 2B. The design of the roller assembly is discussed in more detail in Example 2.

The compression load is applied on the filament by one or more roller balls that are integrated with the nozzle assembly to move either ahead of (pre-nozzle configuration) and/or behind the nozzle (post-nozzle configuration). In practical printing conditions, since the nozzle travels in a U-pattern to print the next line, therefore, the position of the roller with respect to the nozzle changes from one line to the next. If the roller provides pre-deposition rolling in one line because of being ahead of the nozzle, it falls behind the nozzle while printing the next line and therefore provides post-deposition rolling. In contrast, a dual-sided configuration with both pre- and post-nozzle rolling is also studied.

### Example 1

### 3D Printer Setup

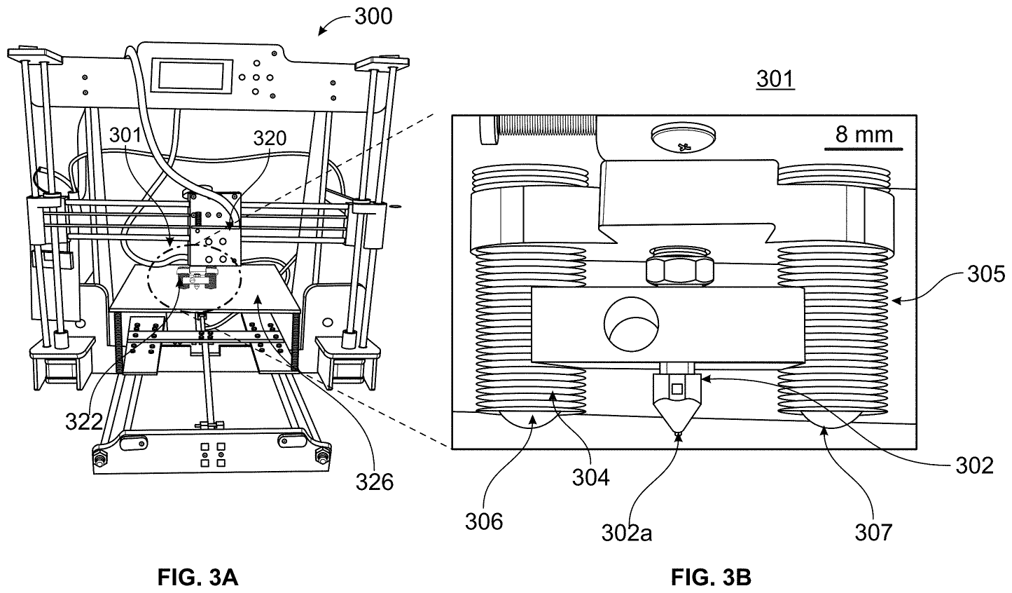

Most commercial desktop 3D printers provide limited access to the site of filament deposition for high-speed imaging and infrared thermography. For this reason, in this work, an open-source Anet A8 3D printer is used, which offers significant operational flexibility. The customized experimental setup 300 is shown in FIG. 3A. FIG. 3A shows, in part, a printer head 320, nozzle assembly 322, and build plate 326. FIG. 3B shows a zoomed-in schematic of nozzle assembly 322 comprising a system 301. System 301 has nozzle 302 having an aperture 302a, a cylinder 304, and 305 positioned on both sides of the nozzle, where each of the cylinders has at least one roller ball 306 and 307. A heated aluminum build plate 326 of 200 mm by 200 mm size maintained at 60° C. is used. An aluminum block is machined to accommodate the nozzle and barrel for polymer feed through. A 40 W resistive heater is embedded into the nozzle heater block along with a thermistor for temperature measurement. All experiments are carried out using Polylactic Acid (PLA) 1.75 mm filament (art number 3D PLA-1KG1.75-BLK from Hatchbox Inc., Ponoma, Calif.). For PLA, a recommended print temperature of 200° C. is maintained by an A1284 mainboard based on feedback from the thermistor. The nozzle diameter is 0.4 mm in all experiments.

First layer height is set to 0.2 mm and is printed with a slower speed of 1000 mm/min to ensure food adhesion of the first layer with the print bed.

The y motion of the build plate 326 and x and z motions of the dispensing nozzle 302 are controlled by stepper motors (not shown). Simplify 3D software is used to convert the CAD geometry of the part to be printed into G-code. The polymer feed rate is adjusted by the software based on the desired layer height and print speed. Per manufacturer recommendation, a layer height setting of 0.37 mm is used for baseline cases without roller compression. When the polymer is compressed through the ball roller, the layer thickness may reduce, resulting in geometrical inaccuracy and build failure. In order to account for this, the layer height specific in the geometrical model is adjusted down by one percentage point per layer to account for the accumulative compression as the layers build up. This one percentage point per layer adjustment is only exemplary and cannot be adjusted as needed.

### Example 2

Integration of the Metal Ball Roller with Nozzle

FIGS. 2A-2B present schematics and pictures of pre-nozzle, post-nozzle as well as combined pre- and post-nozzle rolling arrangements. In each case, 12 mm diameter balls (206 and 207) made up of 440C stainless steel (part number 1598K33, McMaster, Inc. Robbinsville, N.J.) are used in experiments. Balls weigh 7 grams each and are used to apply compression load due to ball weight on the newly deposited filament. For illustration, one ball is shown outside the barrel in FIG. 2B. The nominal applied load due to ball weight is around 0.2N for the three-ball configuration, although the force may vary somewhat due to friction between the balls and barrel surface. The use of bearing quality balls and a slightly larger barrel size compared to ball diameter is expected to minimize friction and ensure the rolling of the balls during printing. The area of contact between the spherical ball and barrel surface is likely to be small and also reduce friction.

Spherical balls are used instead of a cylindrical roller due to easier integration and ease of changing the compressive force by simply changing the number of balls. The balls are painted black for improving IR-based thermal measurements. The balls are contained in two roller cylinders, for example, barrels, that can be placed ahead of or behind the filament-dispensing nozzle (FIG. 2B(i)) or both (FIG. 2B (ii)). Each roller barrel can carry up to three balls.

The roller assembly is shown in more detail in FIG. 3B. The cylinder (304 and 305) carrying the rolling balls (306 and 307) is integrated with the nozzle 322 assembly containing the filament-dispensing nozzle (302). In this unlimiting example, the entire assembly is designed such that the rolling ball is within 17 mm from the filament nozzle. However, it is understood that the positioning of the ball can be adjusted or changed depending on the desired application. As a result, the compression load is applied to the filament immediately after its deposition. This ensures that the compression load is applied on the filament while its temperature is still high, thereby taking advantage of low viscosity. Without wishing to be bound by any theory, it was hypothesized that compressing with a roller at room temperature is likely to be ineffective, as it will result in rapid quenching of filament temperature. As a result, roller balls can be heated, independent of the filament heater, using a 40 W resistive heater connected to each cylinder. In order to independently control the temperatures of the filament nozzle and roller balls, the nozzle heater surface is covered with thermal insulation. A thermistor is placed into the cylinder aluminum block to measure the barrel temperature and provide feedback to Arduino Mega 2560 circuit board. A wait time of around 20 minutes is implemented to reach thermal stability before starting experiments. The set temperature is specified to be slightly above the desired ball temperature in order to account for the small temperature differential that may exist between the barrel and balls. The ball temperature is verified before each experiment through an infrared camera measurement.

### Example 3

High-Speed Visualization and Infrared Temperature Measurement

In situ high-speed imaging and infrared thermography are carried out to understand the effect of the weight and temperature of the rolling ball on the deposited layers. These experiments utilize a FASTEC IL5SM4 high-speed camera mounted to capture the side view of the polymer deposition process. A Navitar 12V 150 W high-intensity fiber optic light source is used for illumination. Image acquisition is carried out at 120 frames per second, with a minimum 3 μs shutter time and 5 μm by 5 μm pixel size. White-colored PLA filament is used in these experiments to improve the quality of images. For these experiments, a thin wall of 100 mm length and a total of four layers is printed.

In addition to high-speed imaging, infrared-based thermal measurements are also carried out to characterize the impact of roller temperature. A FLIR A6703sc InSb infrared camera operating in the 3.0-5.0 μm wavelength range is used for IR thermography. A data capture frame rate of 30 frames per second is used. The infrared emission map measured by the camera is converted into a temperature map using a pre-calibrated value of emissivity. The black-colored filament is used in these experiments due to its higher emissivity, which is measured in advance using calibration experiments described in past papers. While two different colors of PLA are used in high-speed visualization and IR thermography experiments, past work has indicated that there is no significant difference in the properties of Black and White PLA.

### Example 4

### Void Percentage Measurement and Tensile Strength Test

Samples of dimension 100 mm×30 mm×10 mm are printed and cross-sectioned to visualize the effect of compression rolling on void formation. The percentage of voids in the cross-section is measured quantitatively. In order to preserve the mesostructure during the cross-sectioning process, a 0.5 mm cut is made at the center of all edges of the sample, which is then immersed in liquid Nitrogen. Due to the resulting brittleness, the samples can be easily broken by an impact load to reveal the internal mesostructure of the sample, including voids, without distortion. Cross section images of these samples are taken with a 10 Megapixel AmScope microscope digital camera integrated with an AmScope 3X stereomicroscope. Void fraction is calculated using ImageJ software and correlated with process parameters.

Dogbone test coupons for tensile test measurements are printed, per modified version of ASTM D638-2a ‘Standard Test Method for Tensile Properties of Plastics’. The test coupons are 73.68 mm long, 12 mm wide, and 3.2 mm thick. Five samples each of baseline process and with rolling (3 ball weights of pre and post-deposition rolling maintained at 110° C.) are printed at a standard print speed of 60 mm/s. Two sets of test samples are printed. In the first sample, the print direction and loading direction, i.e., the axis of the dogbone sample, are aligned so that the tensile load is applied along the direction of filaments. In the second sample, the print direction is normal to the loading direction so that the load is applied normal to the filaments. Tensile testing is carried out using Shimadzu AGS-X series universal test frame with high precision 5 kN load cell and a pair of mechanical grips with a cross-head speed of 0.02 mm/min.

### Example 5

A number of experiments are carried out in order to investigate the impact of roller pressure and temperature on the printing process as well as the void fraction and tensile properties of printed parts. These experiments mainly examine the impact of two key process parameters—roller weight and roller temperature. The performance of pre-nozzle and post-nozzle rolling configurations is discussed in the next section. A combined dual-sided configuration containing both pre-nozzle and post-nozzle rolling is also discussed below.

### Effect of Roller Ball Weight and Temperature on a Layer Height

### Effect of Roller Ball Weight at a Fixed Temperature

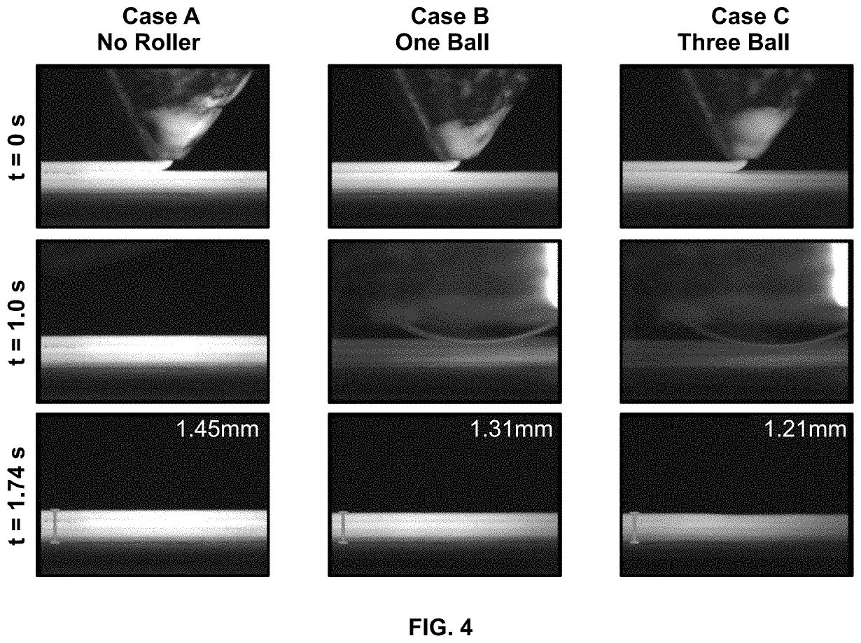

The weight of the roller balls provides the compression load applied on the filament layer. The roller barrel can be loaded with up to three balls—the greater the number of balls, the higher is the load applied on the filament underneath. In order to understand the effect of compression load on the filament, high-speed imaging is carried out for the printing process with the roller barrel loaded with one or three balls (Cases B and C). Results are compared with the baseline case without any compression load (Case A). In each case, the ball temperature is maintained at 110° C. Two filaments of length 100 mm are deposited side-by-side, and four such layers are printed in the z-direction. FIG. 4 shows images from each printing process at three different times during printing of the fourth layer. At t=0 s, the polymer-dispensing nozzle is in view. At t=1.0 s, the nozzle has traveled rightwards out of the frame, and the roller ball is seen compressing the deposited filament for Cases B and C. Once the nozzle and rolling ball passeway from the point of interest at t=1.7 s, layer height is compared for all cases to determine the impact of the rolling process on layer height. Measurement of the layer height based on image analysis of the t=1.7 s images indicates a 17% and 10% reduction in layer height for one ball (Case B) and three balls (Case C) compared to the baseline case.

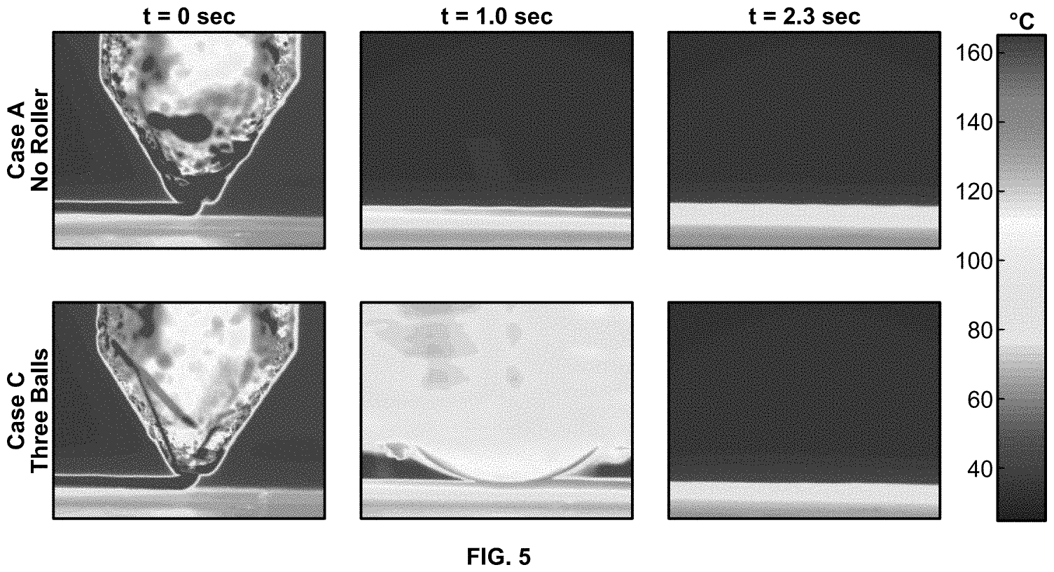

Without wishing to be bound by any theory, it was hypothesized that two distinct mechanisms can exist behind the impact of the roller ball on the mesostructure of the filament layers. The first is a purely mechanical effect caused by filament compression due to the weight of the ball. The second is a thermal effect due to heat transfer to the filament from the hot ball. In order to understand the thermal impact of the roller ball, infrared thermography is carried out on the same process discussed above. FIG. 5 shows successive IR thermal images for the case of compression rolling with three balls at 110° C. starting at t=0 s when the filament deposition occurs. The hot roller ball and its thermal impact are clearly visible in FIG. 5. However, FIG. 5 also shows that the thermal impact of the roller ball is rather localized in time. FIG. 5 shows that the temperature distribution for the roller case returns close to the baseline very quickly after the ball rolls over the point of interest. This is consistent with both the short duration of contact between the ball and filament and the small area of contact expected between the two, limiting the extent of heat transfer.

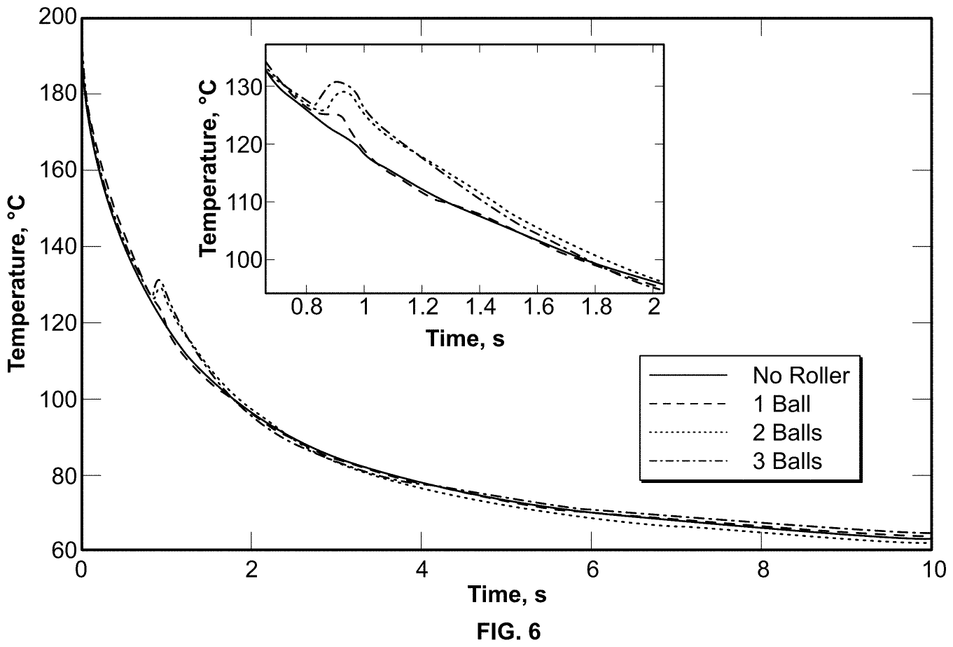

Temperature data are extracted from the thermal images in FIG. 5 and plotted. FIG. 6 plots the temperature of the weld interface between the third and fourth layers as a function of time for the baseline case and printing with one, two, and three roller balls. In this plot, t=0 corresponds to when the nozzle deposits the fourth filament layer at the point of interest. The cooling curves are nearly the same for each case, except for a small peak around t=1.0 s when the roller moves past the point of interest. The inset in FIG. 6 zooms into the period around t=1.0 s. It is seen that the greater the number of balls, the larger is the bump. However, the temperature profile very quickly returns to match the baseline case. Without wishing to be bound by any theory, it was hypothesized that the weld quality between layers depends on the temperature history. However, the temperature bump shown in FIG. 6 is small and short-lived, and the temperature integral does not change by more than 1% for each compared to baseline. Therefore, the significant adhesion improvement obtained here cannot be attributed to temperature rise. Instead, the reduction in total height as seen in FIG. 4, without wishing to be bound by any theory, was mostly attributed to the mechanical compression of the filament due to the roller ball.

Note that for large area printing, the impact of rolling may be limited because the previously-deposited filament may cool down significantly before the roller returns to apply the compressive load. In such a case, rolling may need to be supplemented with directed heat supply to the filament, such as through in situ heating or external energy sources.

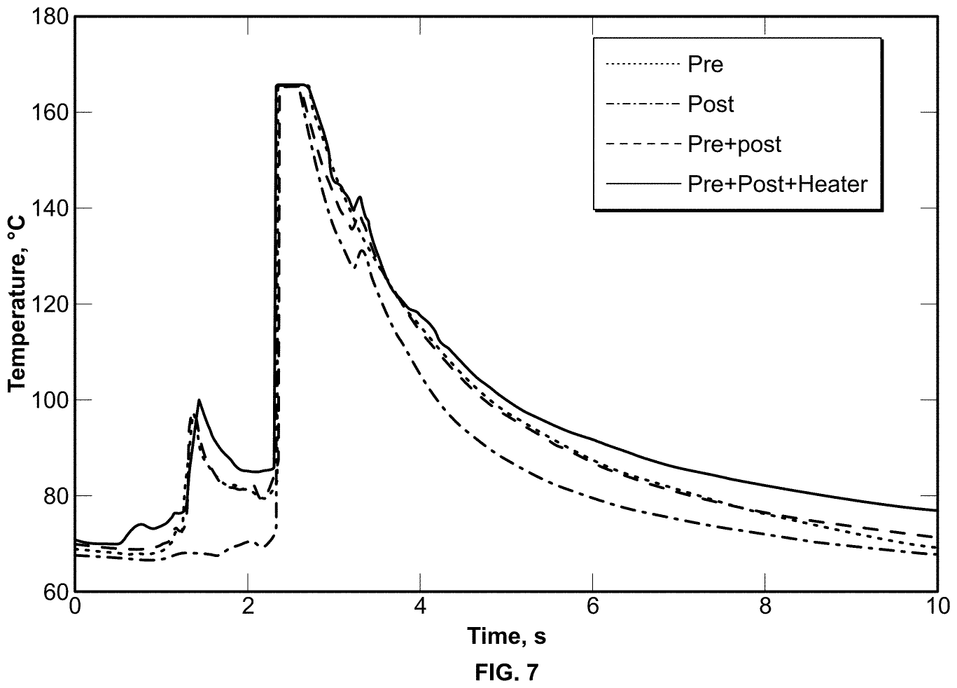

FIG. 7 plots the temperature of the weld interface of the layer deposited by systems shown in FIGS. 1A-1F. In certain aspects, it was found that the combination of rolling and heating can improve the outcome of the process. The localized heating can cause the predeposited layers to soften, and rolling can aid in compression. The softened material is easy to flow and can reduce the voids. As the nozzle deposits a fresh layer on top of the previously heat treated and rolled layer, the post-compression and heat treatment further reduce the void formation. Unexpectedly, the best results were obtained with the system depicted in FIG. 1F.

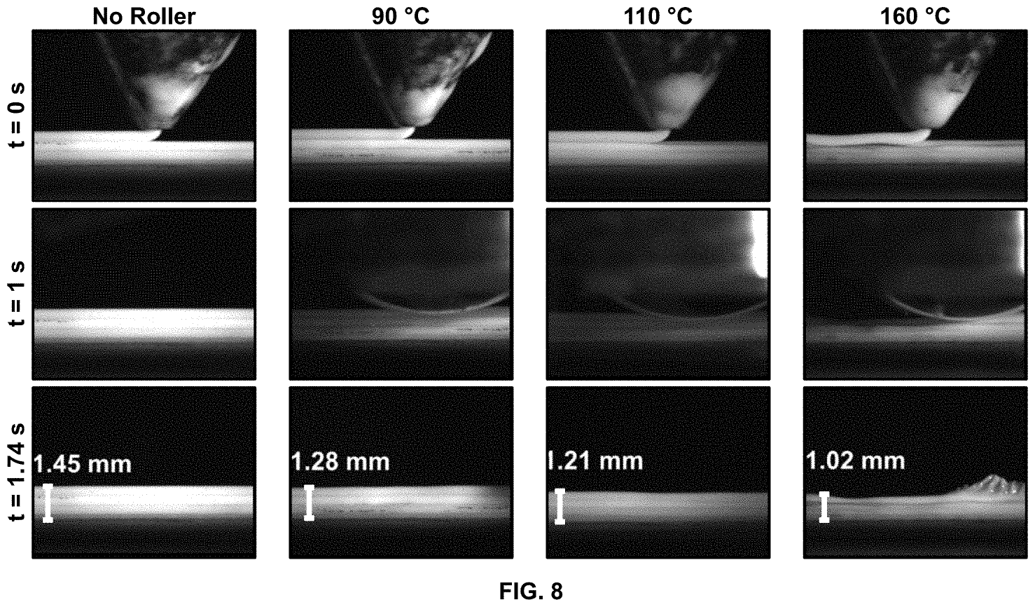

Without wishing to be bound by any theory, it is assumed that the roller ball temperature can be an important parameter because if the ball temperature is too low, it can cause undesirable cooling down of the filament. On the other hand, if a roller temperature is too high, it can cause uneven layer height and polymer removal from the filament by the ball. In order to investigate this aspect further, experiments are carried out at three different roller ball temperatures—90, 110, and 160° C.—and compared with the baseline no-roller case. In each case, three balls are loaded in the barrel in order to maintain the same compression load. All other print process conditions are the same as for FIGS. 4 and 5. FIG. 8 compares high-speed images for these cases with the baseline case of zero compression. As the roller ball temperature increases, there is a progressively greater reduction in the layer height since the filament is softer at higher temperatures. However, at high roller ball temperatures, the deposited polymer sticks back to the moving roller ball, as seen in the last column for 160° C. ball temperature in FIG. 8. It is understood that such results can be undesirable, as it results in uneven layer height and part build failure. For this case, small fragments of polymers are found to be stuck on the roller ball after completing the printing process.

### Void Fraction Measurement

Void fraction measurements are carried out on parts printed with roller ball compression for comparison with baseline parts. The parts printed for this purpose are much larger than the ones used in the previous section. The overall part size is 100 mm×30 mm×10 mm, with a print orientation of 0° and roller configuration similar to the one shown in FIG. 2B(i). During the print process, the nozzle moves back and forth along the 100 mm long x-direction. As a result, in one pass, the roller provides post-deposition compression when it moves ahead of the nozzle, and in the next pass after a U-turn, it provides pre-deposition compression because it now moves behind the nozzle. Samples are printed with either one or three roller balls and at three different speeds—2000, 2800, and 3600 mm/min—in addition to the baseline case. Note that 3600 mm/min is the manufacturer-recommended print speed. The roller balls are maintained at 110° C. in each case. Three replicates of samples are printed for each test case. The samples are cross-sectioned, and the void fraction is measured as described above.

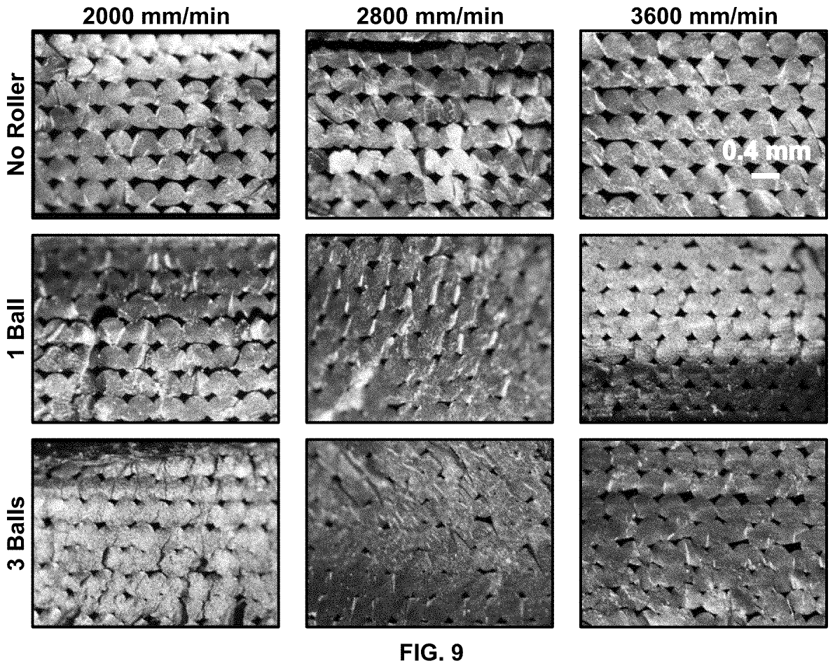

FIG. 9 shows sample cross-sections for one and three ball cases for three different print speeds. These cross-section images clearly show improved neck growth and reduced voiding for both one-ball and three-ball cases compared to the baseline. These results are consistent with the layer height measurements shown in the high-speed images in FIG. 4. The baseline images for 2000 mm/min speed show poor contact between layers because the speed is much lower than the manufacturer-recommended 3600 mm/min setting.

The intermediate speed of 2800 mm/min appears to perform better than the other two speeds in terms of void fraction reduction. Without wishing to be bound by any theory, it was explained as follows: at too low a speed, a large time passes before the roller reaches the deposited filament, by when the filament has already cooled down significantly, thereby limiting the impact of the rolling process. On the other hand, at too high a speed, the filament experiences the compression load over a very short time, which also limits the impact of the rolling process. An intermediate speed is likely to be optimal. Optionally, the optimal speed can be tuned by changing the distance between the filament nozzle and the roller. For example, bringing the two closer to each other will ensure that the deposited filament is still hot enough when the roller comes in contact. It is also hypothesized that the optimal speed can also be a function of the properties of the polymer.

The void percentage is determined quantitatively as described above and plotted in FIGS. 10A and 10B. FIGS. 10A and 10B plot the average void percentage over three replicates as a function of print speed and ball weight for one-ball and three-ball cases, respectively. Three temperatures −90° C., 100° C., and 110° C.—are used. The 160° C. case is excluded from FIGS. 10A and 10B because it leads to a poor part quality due to polymer sticking to the ball and uneven layer height, as shown in FIG. 8 FIGS. 10A and 10B show a significant reduction in void fraction for all compression rolling cases compared to the no-roller baseline. In general, the three-ball case offers greater improvement than the one-ball case. The best performance is seen for the ball temperature of 110° C. and print speed of 2800 mm/min, although other cases are also quite close. For this case, the void fraction for the three-ball and one-ball cases is 2.5% and 4.5%, respectively, representing a significant improvement compared to the baseline value of 10.8%. Note that the 2000 mm/min print speed is much lower than the manufacturer-recommended setting, and therefore, care must be taken when comparing baseline and roller samples at this speed.

### Dual-Sided Rolling

In contrast to the pre-nozzle or post-nozzle compression presented so far, an alternate approach of providing dual-sided rolling is also investigated. In this case, as shown in FIG. 2B (ii), two roller barrels are integrated on both sides of the rastering nozzle so that pre-nozzle and post-nozzle compression are both provided simultaneously. These experiments are carried with a roller ball temperature of 110° C. and a standard print speed of 3600 mm/min. High-speed imaging of this process shows a 21% reduction in layer height due to the dual rolling compared to the baseline, which is slightly greater than the 16% reduction seen for the single-sided rolling discussed in FIG. 10.

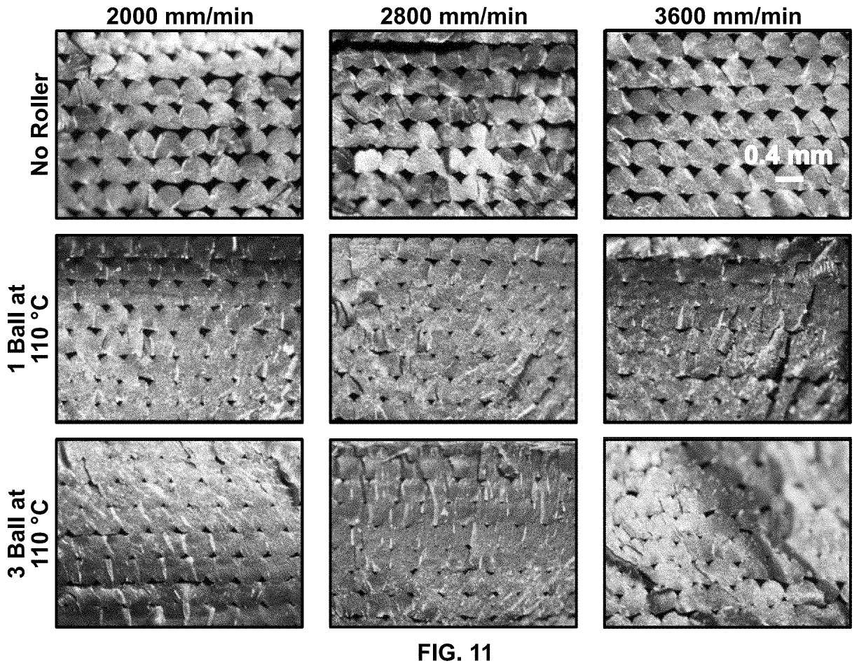

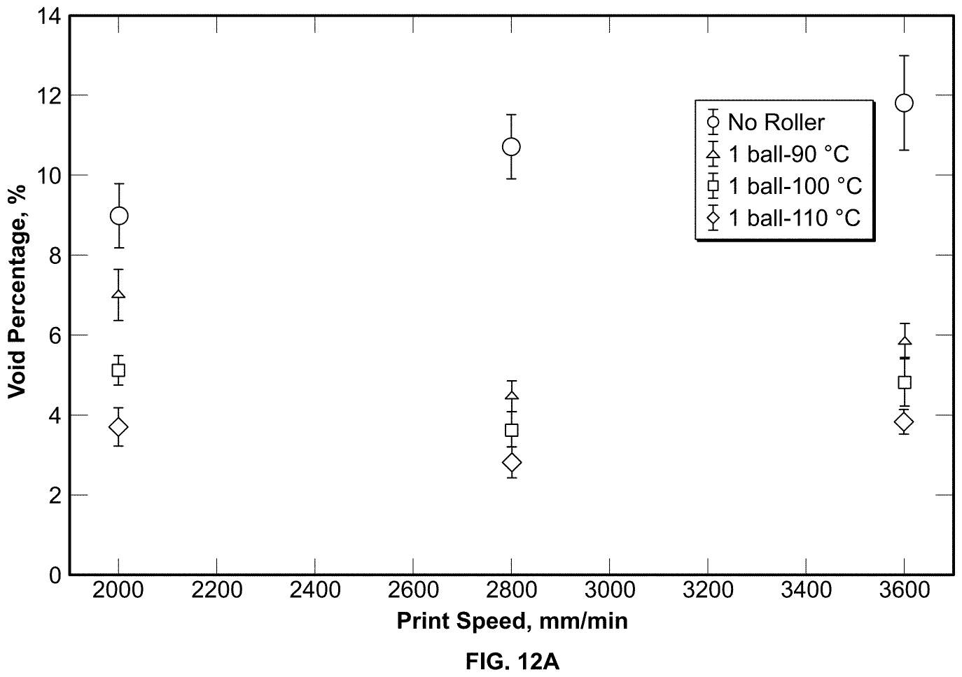

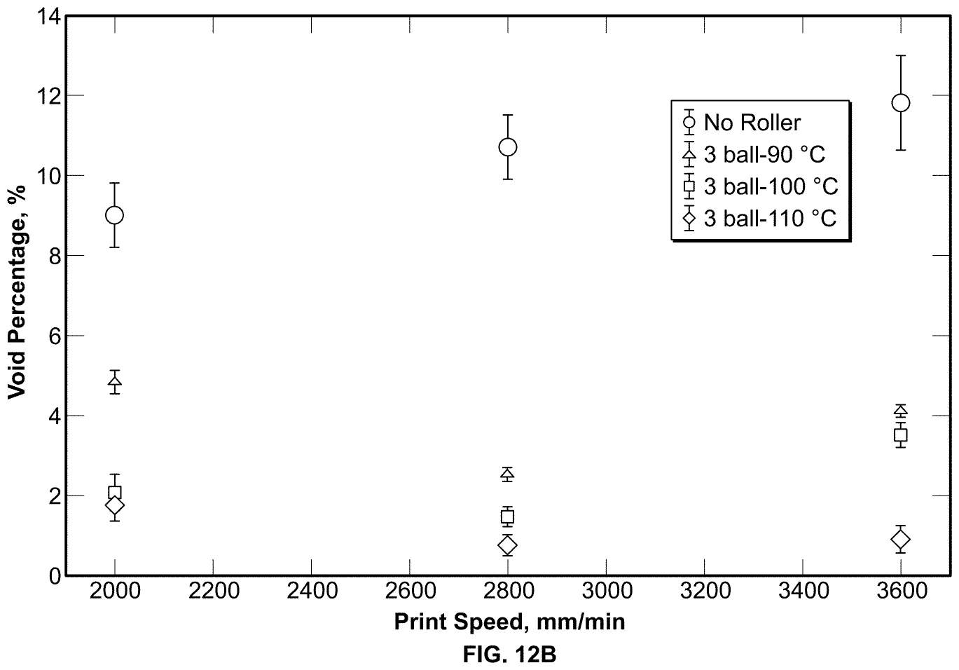

FIG. 11 shows cross-sections images for void characterization of the dual-sided rolling approach. The improvement in voiding due to dual-sided rolling is clearly seen when compared to the baseline. The improvement is even greater than in the single-sided rolling case (FIG. 10). FIGS. 12A and 12B plot the void percentage as a function of print speed and ball temperature for one ball and three ball cases. These images and void percentage data show even greater improvement in void formation for the dual-sided rolling compared to the single-side rolling case. For 2800 mm/min print speed with three rolling balls, the void fraction reduced to only 0.7% compared to the baseline value of 10.8%, which is a significant improvement that nearly eliminates voids.

### Impact of the Overall Geometry

Since the roller ball causes mechanical compression of the filament, it is important to ensure that this technique does not result in distortion of the overall geometrical dimensions of the printed part. In order to characterize this effect, a standard parallelepiped sample is printed with s three ball roller compression with a ball temperature of 110° C. As a baseline, the sample is also printed without roller compression. In both cases, the print speed is 2800 mm/min. The overall geometrical dimension of the printed parts is measured and summarized in Table 1.

Data in Table 1 show that geometrical distortion occurs primarily in the build direction only, which is not surprising since the compression load is applied in that direction. The key reason behind distortion in the build direction is that the CAD model of the sample did not take into account the dimensional reduction caused by the compression roller. While the reduction in voiding due to compression roller is certainly desirable, steps also need to be taken to minimize the resulting impact on the geometrical accuracy of the printed part.

One possible way to ensure this is to simply revise the CAD model dimensions upwards to counteract the expected reduction. While this simplistic approach is found to work well for simple parts such as one printed herein, further research is needed to fully understand and implement such a correction in parts with more complicated geometry. This will help retain the beneficial effect of void reduction through compression rolling while preserving the geometrical accuracy of the printed part.

TABLE 1
Comparison of tensile test properties of compression-printed parts
with baseline parts. Data are presented for two samples
that are printed along with or normal to the load direction

| X | | | | | | Z | | |
|---|---|---|---|---|---|---|---|---|
| (Raster Direction) | | | Y | | | (Build Direction) | | |
| Baseline (mm) | Rolled (mm) | % Change | Baseline (mm) | Rolled (mm) | % Change | Baseline (mm) | Rolled (mm) | % Change |
| 80.3 | 80.7 | +0.5 | 9.9 | 10.1 | +1.98 | 8.1 | 6.44 | −20.5 |

### Tensile Tests

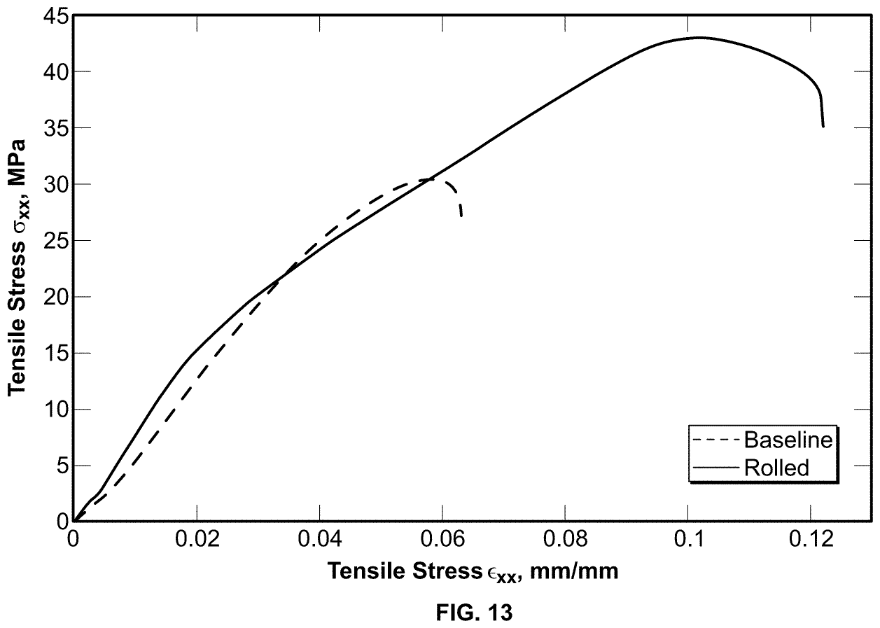

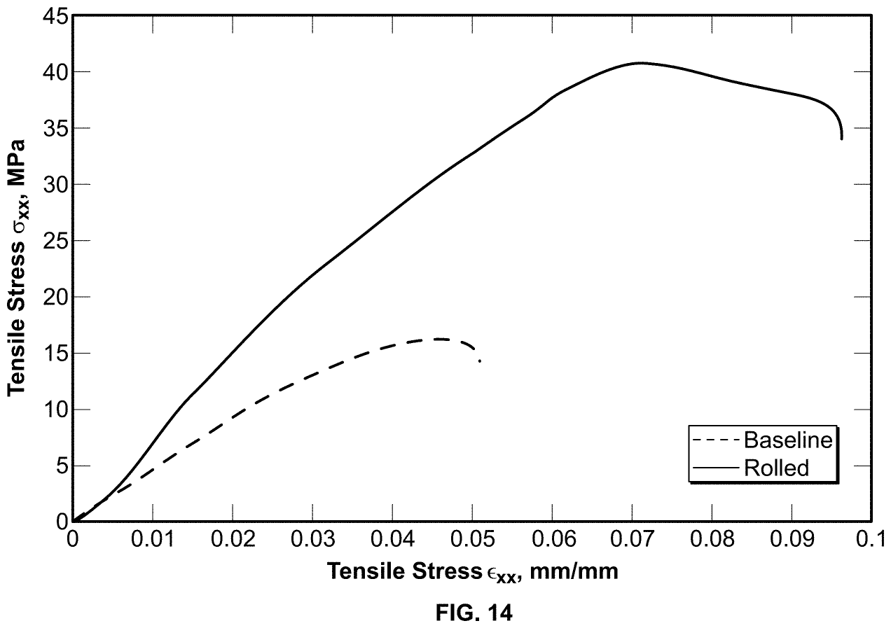

The impact of compression rolling of filaments on mechanical properties of printed parts is investigated through tensile testing. Without wishing to be bound by any theory, it was assumed that the void reduction seen in FIG. 9-12 will result in improved tensile properties. Two distinct samples are printed at a manufacturer-recommended speed of 3600 mm/min to investigate the impact on tensile properties. In Sample A, the filaments are printed along the same direction as the direction of application of the tensile load (0° angle between the print direction and the load direction, which is the axis of the dogbone sample). The stress-strain curve for this sample is shown in FIG. 13. All results from the tensile test are summarized in Table 2. Compared to baseline, data show 34% improvement in Ultimate Tensile Stress (UTS) and 281% improvement in material toughness. The second test is carried out on Sample B, in which the tensile load is applied normal to the print direction (90° angle between the print direction and load direction). Data for Sample B, shown in FIG. 14 and Table 2, demonstrate even greater improvement in tensile properties—a 149% improvement in UTS and 495% improvement in material toughness. At-test of the measurements for both ultimate tensile stress and toughness shows that for both Samples A and B, the reported improvements are statistically significant (ρ<0.001).

TABLE 2
Comparison of tensile test properties of compression-printed parts
with baseline parts. Data are presented for two samples that are
printed along with or normal to the load direction.

| | | | Increase | | |
|---|---|---|---|---|---|
| | | Ultimate | in ultimate | | Increase in |
| | | strength | tensile | Toughness | toughness, |
| Description | | (MPa) | strength, % | (MJ/m³) | % |
| Sample | Baseline | 33.3 ± 2.4 | 34% | 1.1 ± 0.2 | 281% |
| A | Compressive | 44.7 ± 1.5 | | 4.2 ± 0.8 | |
| | rolling aligned | | | | |
| | with tensile | | | | |
| | load direction | | | | |
| Sample | Baseline | 15.5 ± 0.9 | 149% | 0.4 ± 0.05 | 495% |
| B | Compressive | 38.6 ± 1.8 | | 2.6 ± 0.3 | |
| | rolling normal | | | | |
| | to the tensile | | | | |
| | load direction | | | | |

The fracture surfaces for rolled samples appear to differ from the baseline samples in both cases investigated herein (i.e., when the printing direction is aligned with or normal to the load direction). It is believed that the failure process is governed by crazing, and the presence of crazing is more pronounced on the fracture surface of the rolled coupons. Necking before fracture is observed during tensile testing, which is also discernible from the stress-strain curves of the rolled samples. The presence of crazing the rolled sample also supports the increase in material toughness.

It is expected that rolling on the just-deposited filaments while still hot and soft deforms the filaments in the lateral direction, thereby filling gaps between filaments, improving interfacial bonding, and reducing void formation. The reduced gap between filament is clearly seen in cross-section images in FIGS. 9 and 11. Rolling also works to reshape the filaments, resulting in increasing the notch angle at the interface. Rolling may also help improve the singularity order, which enhances the material toughness, as is evident in FIG. 14.

Tensile toughness of a material is described by the ability of the material to absorb tensile fracture energy during stretching. For PLA, tensile toughness can be increased through two distinct mechanisms—shear yielding and crazing energy. It was found that shear yielding is the most effective mechanism for significant change in toughness. As evident from the tensile stress0strain cures, it is believed that the rolling process and temperature collectively rearrange the internal molecular structure of PLA, which, in turn, enhances plasticity (shear yielding) in the material. In addition, rolling may also help align polymer chains along the printing direction, which may have contributed to the improved UTS when loaded along the filament direction, as shown in FIG. 13.

A comparison between FIGS. 13 and 14 shows that the UTS values are very similar for Samples A and B that are printed/rolled along and normal to the loading directions, respectively. In contrast, the UTS of the baseline sample with 90° angle between printing and loading directions is much lower—nearly half—than that of the baseline sample with 0 degrees loading angle. This indicates that the compressive load due to rolling is likely resulting in improved interdiffusion of polymer chains, and thereby, a better degree of healing. While more theoretical modeling may be needed to completely characterize the impact of compression rolling on the polymer interdiffusion process, data presented here indicate that hot rolling of filaments may help address two key challenges in the 3D printing process—the degree of anisotropy in tensile properties, and the weakness of 3D printed parts under transverse loading.

The claims are not intended to include, and should not be interpreted to include, means-plus- or step-plus-function limitations, unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein, or that the “particular” aspects are somehow limited in some way other than the inherent meanings of the language and formulas literally used therein.

What is claimed is:

1. A system comprising:
a) a nozzle comprising an aperture configured to dispense a material to form a material layer on a build plate; the nozzle is configured to move along x, y, and/or z-axis, and/or is configured to rotate; and wherein there is substantially no contact between any part of the nozzle other than an optional contact of the nozzle's aperture and the layer of the material and/or the build plate during dispense and/or the nozzle's movement and/or rotation; and
b) one or more members positioned in a spatial configuration along the x and z-axis relative to the nozzle such that the one or more members are configured to apply a compression load on the layer of the material, wherein at least one of the one or more members comprises a cylinder having a proximal end and a distal end, wherein the cylinder comprises at least one roller ball having a diameter d1, wherein the distal end of the cylinder has an aperture having a diameter d2, wherein the d2 is smaller than d1, and wherein the aperture is configured to partially expose the at least one roller ball to the material layer and/or the build plate such that at least a portion of the roller ball is in contact with the material layer and/or the build plate, and wherein the at least one roller ball is configured to at least partially move along the z-axis and/or rotate within the cylinder.

2. The system of claim 1, wherein the spatial configuration comprises positioning the one or more members such that the one or more members pre-face the nozzle in the x-axis direction or the one or more members trail the nozzle in the x-axis direction.

3. The system of claim 2, wherein the system comprises two members positioned such that a first member pre-faces the nozzle and a second member trails the nozzle in the x-axis direction.

4. The system of claim 3, wherein each of the first and the second members comprise the cylinder comprising the at least one roller ball.

5. The system of claim 3, wherein the first member comprises the cylinder comprising the at least one roller ball and the second member comprises a heat transfer block.

6. The system of claim 1, wherein the cylinder comprises two or more roller balls, wherein each of the roller balls is configured to at least partially rotate or move along the z-axis within the cylinder.

7. The system of claim 1, wherein each of the one or more members configured to apply the same or different compression load, and wherein the compression load is up to about 1 N.

8. The system of claim 1, wherein the at least one roller ball that is in contact with the material layer and/or builds plate is configured to move within the cylinder in response to a geometry of the material layer and/or the build layer.

9. The system of claim 1, wherein the one or more members are positioned within about 0.5 mm to about 50 mm from the nozzle in the x-axis direction.

10. The system of claim 1, the nozzle and the one or more members are heated at a temperature between about 30° C. to about 250° C.

11. The system of claim 10, wherein the nozzle and the one or more members are heated independently to the same or a different temperature.

12. The system of claim 1, wherein the build plate is heated.

13. The system of claim 1, wherein the one or more members are removably attached to the nozzle and configured to move along x, y, and z-axis simultaneously with the nozzle.

14. The system of claim 1, wherein the nozzle is configured to move at speed between about 1000 mm/min and about 4000 mm/min.

15. The system of claim 1, wherein the system further comprises a control unit configured to independently adjust a temperature of the nozzle, build plate, the one or more members, and/or a speed of the nozzle.

16. The system of claim 15, further comprising at least one sensor configured to measure a temperature of the nozzle, build plate, and/or the one or more members, and/or a speed of the nozzle, compression load, and/or a thickness of the one or more layers, and wherein the at least one sensor in a feedback loop with the control unit.

17. The system of claim 1, configured to form at least two material layers wherein a void fraction of the at least two material layers is at least about 40% lower when compared to a substantially identical system with an absence of the one or more members.

18. A manufactured part comprising a plurality of compressed filaments, wherein
a plurality of first compressed filaments forming a first layer,
a plurally of second compressed filaments forming a second layer compressed against the first layer,
wherein a plurality of last compressed filaments forming a last layer compressed against a layer before the last layer, and
wherein a void fraction of the manufactured part is between about 0.01% to about 10%.

19. The manufactured part of claim 18, wherein any two adjacent compressed filaments in each layer are compressed against each other.

20. The manufactured part of claim 19, wherein the part exhibits ultimate strength between about 30 MPa to about 100 MPa and/or a toughness between about 2 to about 5 MJ/m³.

21. A method of forming a manufactured part, wherein the method comprising:
a) disposing a material on a building plate from an aperture of a nozzle to form a layer of material, wherein the nozzle is configured to move along x, y, and/or z-axis, and/or is configured to rotate; and wherein there is substantially no contact between any part of the nozzle other than an optional contact of the nozzle's aperture and the layer of the material and/or the build plate during disposing step and/or the nozzle's movement and/or rotation;
b) applying a compression load on at least a portion of the layer of material with one or more members, wherein the one or more members positioned in a spatial configuration along x and z-axis relative to the nozzle such that the one or more members are configured to apply a compression load on the one or more layers of the material, wherein at least one of the one or more members comprises a cylinder having a proximal end and a distal end, wherein the cylinder comprises at least one roller ball having a diameter d1, wherein the distal end of the cylinder has an aperture having a diameter d2, wherein the d2 is smaller than d1, and wherein the aperture is configured partially expose the at least one roller ball to the material layer and/or the build plate such that at least a portion of the roller ball is in contact with the material layer and/or the build plate, and wherein the at least one roller ball is configured to at least partially move along the z-axis and/or rotate within the cylinder; and
c) forming the manufactured part having a void fraction of between about 0.01% to about 10%.

22. The method of claim 21, wherein the disposing step comprises moving the nozzle in the x or y-axis direction at speed between about 1000 mm/min and about 4000 mm/min.

23. The method of claim 21, wherein the method comprises heating the nozzle and/or one or more members at a temperature between about 30° C. to about 250° C.

24. The method of claim 21, wherein dimensions of the manufactured product are adjusted by at least about 0.1% to compensate for a change in a thickness of the one or more layers due to the applied predetermined compression load.
